(19) United States
(12) Patent Application Publication
(10) Pub. No.: US 2014/0006676 A1
(43) Pub. Date: Jan. 2, 2014

(54) SYSTEMS AND METHODS FOR DYNAMIC ALLOCATION OF INFORMATION HANDLING RESOURCES

(71) Applicants: BABU CHANDRASEKHAR, Round Rock, TX (US); Michael A. Brundridge, Georgetown, TX (US); Syama Poluri, Round Rock, TX (US)

(72) Inventors: BABU CHANDRASEKHAR, Round Rock, TX (US); Michael A. Brundridge, Georgetown, TX (US); Syama Poluri, Round Rock, TX (US)

(73) Assignee: Dell Products L.P., Round Rock, TX (US)

(21) Appl. No.: 13/536,023

(22) Filed: Jun. 28, 2012

(51) Int. Cl. G06F 13/36

(52) U.S. Cl. 710/316

(57) ABSTRACT

One or more chassis management controllers housed in a modular chassis may be configured to (i) monitor a first information handling resource allocated to one or more modular information handling systems engaged in the chassis to determine if a triggering event associated with the first information handling resource occurs; (ii) in response to the triggering event, allocate a substitute information handling resource for the one or more information handling systems to which the first information handling resource is allocated; and (iii) in response to the triggering event, deallocate the first information handling resource from the one or more information handling systems to which the first information handling resource is allocated.

### TECHNICAL FIELD

The present disclosure relates in general to information handling systems, and more particularly to allocation of information handling resources to modular information handling systems in a chassis.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Existing server architectures either provide a single monolithic server capable of running one operating system (or a single hypervisor running multiple virtualized operating systems) and input/output (“I/O”) resources at a time, or bulky blade server chassis providing multiple servers and I/O control modules in a single chassis. A system chassis with multiple information handling systems with various peripheral and input/output capabilities common to the chassis as a whole may provide advantages, as it allows a blade server chassis in a small form factor, thereby providing a blade server chassis with a size comparable to the size of a monolithic server. Implementation of a system chassis with multiple information handling systems with various peripheral and input/output capabilities common to the chassis as a whole presents numerous challenges.

### SUMMARY

In accordance with the teachings of the present disclosure, the disadvantages and problems associated with allocation of information handling resources in a shared input/output infrastructure have been reduced or eliminated.

In accordance with one or more embodiments of the present disclosure, a system may include a chassis, one or more switches, and one or more chassis management controllers. The chassis may be configured to receive a plurality of modular information handling systems and a plurality of modular information handling resources, each information handling resource received through a slot in the chassis. The one or more switches may be configured to provide access of one of the modular information handling resources to one or more of the plurality of modular information handling systems. The one or more chassis management controllers may be housed in the chassis and configured to (i) monitor a first information handling resource allocated to one or more modular information handling systems engaged in the chassis to determine if a triggering event associated with the first information handling resource occurs; (ii) in response to the triggering event, allocate a substitute information handling resource for the one or more information handling systems to which the first information handling resource is allocated; and (iii) in response to the triggering event, deallocate the first information handling resource from the one or more information handling systems to which the first information handling resource is allocated.

In accordance with these and other embodiments of the present disclosure, a system may include a chassis, one or more switches, and one or more chassis management controllers. The chassis may be configured to receive a plurality of modular information handling systems and a plurality of modular information handling resources, each information handling resource received through a slot in the chassis. The one or more switches may be configured to provide access of one of the modular information handling resources to one or more of the plurality of modular information handling systems. The one or more chassis management controllers housed in the chassis and configured to: (i) monitor a first information handling resource allocated to one or more modular information handling systems engaged in the chassis to determine if a first triggering event associated with the first information handling resource occurs; and (ii) in response to the first triggering event, allocate an additional information handling resource for all of a portion of the one or more information handling systems to which the first information handling resource is allocated, such that processing and functionality carried out by the first information handling resource prior to the occurrence of the first triggering event is shared between the first information handling resource and the additional information handling resource.

In accordance with these and other embodiments of the present disclosure, a system may include may include a chassis, one or more switches, and one or more chassis management controllers. The chassis may be configured to receive a plurality of modular information handling systems and a plurality of modular information handling resources, each information handling resource received through a slot in the chassis. The one or more switches may be configured to provide access of one of the modular information handling resources to one or more of the plurality of modular information handling systems. The one or more chassis management controllers may be housed in the chassis and configured to (i) monitor a first information handling resource allocated to one or more modular information handling systems engaged in the chassis to determine if a failure associated with the first information handling resource occurs; (ii) in response to the failure, allocate a substitute information handling resource for the one or more information handling systems to which the first information handling resource is allocated; and (iii) in response to the failure, deallocate the first information handling resource from the one or more information handling systems to which the first information handling resource is allocated.

Technical advantages of the present disclosure will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example system chassis with multiple information handling systems and with various peripheral and input/output capabilities common to the chassis as a whole, in accordance with certain embodiments of the present disclosure;

FIG. 2 illustrates a more detailed block diagram of example system configured to provide for dynamic power allocation of information handling resources in a modular chassis for switches and devices in a multi-root input-output virtualization (“IOV”) environment for multiple information handling systems, in accordance with certain embodiments of the present disclosure;

FIG. 3 illustrates a flow chart of an example method for dynamic allocation of information handling resources to information handling systems in a chassis, in accordance with certain embodiments of the present disclosure;

FIG. 4 illustrates a flow chart of another example method for dynamic allocation of information handling resources to information handling systems in a chassis, in accordance with certain embodiments of the present disclosure; and

FIG. 5 illustrates a flow chart of an example method for failover of an information handling resources associated with one more information handling systems in a chassis, in accordance with certain embodiments of the present disclosure.

### DETAILED DESCRIPTION

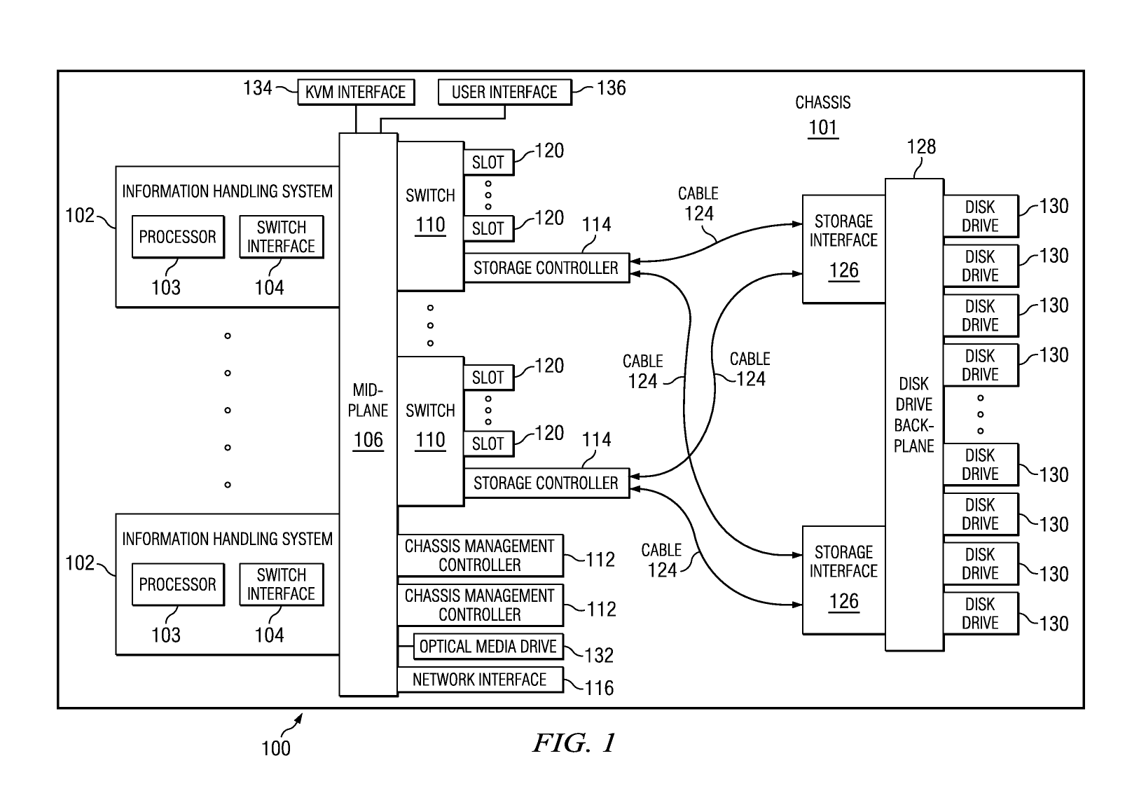

Preferred embodiments and their advantages are best understood by reference to FIGS. 1-5, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system may include memory, one or more processing resources such as a central processing unit (“CPU”) or hardware or software control logic. Additional components or the information handling system may include one or more storage devices, one or more communications ports for communicating with external devices as well as various input and output (“I/O”) devices, such as a keyboard, a mouse, and a video display. The information handling system may also include one or more buses operable to transmit communication between the various hardware components.

For the purposes of this disclosure, information handling resources may broadly refer to any component system, device or apparatus of an information handling system, including without limitation processors, busses, memories, input-output devices and/or interfaces, storage resources, network interfaces, motherboards, electro-mechanical devices (e.g., fans), displays, and power supplies.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (“RAM”), read-only memory (“ROM”), electrically erasable programmable read-only memory (“EEPROM”), and/or flash memory; as well as communications media such wires, optical fibers, microwaves, radio waves, and other electromagnetic and/or optical carriers; and/or any combination of the foregoing.

Information handling systems often use an array of physical storage resources (e.g., disk drives), such as a Redundant Array of Independent Disks (“RAID”), for example, for storing information. Arrays of physical storage resources typically utilize multiple disks to perform input and output operations and can be structured to provide redundancy which may increase fault tolerance. Other advantages of arrays of physical storage resources may be increased data integrity, throughput and/or capacity. In operation, one or more physical storage resources disposed in an array of physical storage resources may appear to an operating system as a single logical storage unit or “logical unit.” Implementations of physical storage resource arrays can range from a few physical storage resources disposed in a chassis, to hundreds of physical storage resources disposed in one or more separate storage enclosures.

FIG. 1 illustrates a block diagram of an example system 100 having a chassis 101 with multiple information handling systems 102 and with various peripheral and input/output capabilities common to chassis 101 as a whole, in accordance with certain embodiments of the present disclosure. As depicted in FIG. 1, system 100 may comprise a chassis 101 including a plurality of information handling systems 102, a mid-plane 106, one or more switches 110, one or more chassis management controllers 112, a network interface 116, one or more slots 120, one or more cables 124, one or more storage interfaces 126, a disk drive backplane 128, a plurality of disk drives 130, an optical media drive 132, a keyboard-video-mouse (“KVM”) interface 134, and a user interface 136.

An information handling system 102 may generally be operable to receive data from and/or communicate data to one or more disk drives 130 and/or other information handling resources of chassis 101 via mid-plane 106 and/or switches 110. In certain embodiments, an information handling system 102 may be a server. In such embodiments, an information handling system may comprise a blade server having modular physical design. In these and other embodiments, an information handling system 102 may comprise an M class server. As depicted in FIG. 1, an information handling system 102 may include a processor 103 and one or more switch interfaces 104 communicatively coupled to processor 103.

A processor 103 may include any system, device, or apparatus configured to interpret and/or execute program instructions and/or process data, and may include, without limitation a microprocessor, microcontroller, digital signal processor (“DSP”), application specific integrated circuit (“ASIC”), or any other digital or analog circuitry configured to interpret and/or execute program instructions and/or process data. In some embodiments, processor 103 may interpret and/or execute program instructions and/or process data stored in a memory, a hard drive 130, and/or another component of system 100.

A switch interface 104 may comprise any system, device, or apparatus configured to provide an interface between its associated information handling system 102 and switches 110. In some embodiments, switches 110 may comprise Peripheral Component Interconnect Express (“PCIe”) switches, in which case a switch interface 104 may comprise a switch card configured to create a PCIe-compliant interface between its associated information handling system 102 and switches 110. In other embodiments, a switch interface 104 may comprise an interposer. Use of switch interfaces 104 in information handling systems 102 may allow for minimal changes to be made to traditional servers (e.g., M class servers) while supporting the overall system architecture disclosed herein. Although FIG. 1 depicts an implementation including a single switch interface 104 per information handling system 102, in some embodiments each information handling system 102 may include a plurality of switch interfaces 102 for redundancy, high availability, and/or other reasons.

Mid-plane 106 may comprise any system, device, or apparatus configured to interconnect modular information handling systems 102 with information handling resources. Accordingly, mid-plane 106 may include slots and/or connectors configured to receive information handling systems 102, switches 110, chassis management controllers 112, storage controllers 114, network interface 116, optical media drive 132, KVM interface 134, user interface 136, and/or other information handling resources. In one embodiment, mid-plane 106 may include a single board configured to interconnect modular information handling systems 102 with information handling resources. In another embodiment, mid-plane 106 may include multiple boards configured to interconnect modular information handling systems 102 with information handling resources. In yet another embodiment, mid-plane 106 may include cabling configured to interconnect modular information handling systems 102 with information handling resources.

A switch 110 may comprise any system, device, or apparatus configured to couple information handling systems 102 to storage controllers 114 (e.g., via mid-plane 106) and slots 120 and perform switching between information handling systems 102 and various information handling resources of system 100, including storage controllers 114 and slots 120. In certain embodiments, a switch 110 may comprise a PCIe switch. In other embodiments, a switch may comprise a generalized PC bus switch, an Infiniband switch, or other suitable switch. As shown in FIG. 1, chassis 101 may include a plurality of switches 110. In such embodiments, switches 110 may operate in a redundant mode for shared devices (e.g., storage controllers 114 and/or devices coupled to slots 120) and in non-redundant mode for non-shared/zoned devices. As used herein, shared devices may refer to those which may be visible to more than one information handling system 102, while non-shared devices may refer to those which are visible to only a single information handling system 102. In some embodiments, mid-plane 106 may include a single switch 110.

A chassis management controller 112 may be any system, device, or apparatus configured to facilitate management and/or control of system 100, its information handling systems 102, and/or one or more of its component its component information handling resources. A chassis management controller 102 may be configured to issue commands and/or other signals to manage and/or control information handling system 102 and/or information handling resources of system 100. A chassis management controller 112 may comprise a microprocessor, microcontroller, DSP, ASIC, field programmable gate array (“FPGA”), EEPROM, or any combination thereof. As shown in FIG. 1, a chassis management controller 112 may be coupled to mid-plane 106. Also as shown in FIG. 1, system 100 may include a plurality of chassis management controllers 112, and in such embodiments, chassis management controllers 112 may be configured as redundant. In some embodiments, a chassis management controller 112 may provide a user interface and high level controls for management of switches 110, including configuring assignments of individual information handling systems 102 to non-shared information handling resources of system 100. In these and other embodiments, a chassis management controller may define configurations of the storage subsystem (e.g., storage controllers 114, storage interfaces 126, disk drives 130, etc.) of system 100. For example, a chassis management controller may provide physical function configuration and status information that would normally occur at the driver level in traditional server implementations. Examples of physical functions include disk drive discovery and status, RAID configuration and logical volume mapping.

In addition or alternatively, a chassis management controller 112 may also provide a management console for user/administrator access to these functions. For example, a chassis management controller 112 may implement Web Services Management (“WS-MAN”) or another suitable management protocol permitting a user to remotely access a chassis management controller 112 to configure system 100 and its various information handling resources. In such embodiments, a chassis management controller 112 may interface with a network interface separate from network interface 116, thus allowing for “out-of-band” control of 100, such that communications to and from chassis management controller 112 are communicated via a management channel physically isolated from an “in band” communication channel with network interface 116. Thus, for example, if a failure occurs in system 100 that prevents an administrator from interfacing with system 100 via network interface 116 and/or user interface 136 (e.g., operating system failure, power failure, etc.), the administrator may still be able to monitor and/or manage system 100 (e.g., to diagnose problems that may have caused failure) via a chassis management controller 112. In the same or alternative embodiments, chassis management controller 112 may allow an administrator to remotely manage one or more parameters associated with operation of system 100 and its various information handling resources (e.g., power usage, processor allocation, memory allocation, security privileges, etc.). Although FIG. 1 depicts chassis as having two chassis management controllers 112, chassis 101 may include any suitable number chassis management controllers 112.

A storage controller 114 may include any system, apparatus, or device operable to manage the communication of data between one or more of information handling systems 102 and one or more of disk drives 130. In certain embodiments, a storage controller 114 may provide functionality including, without limitation, disk aggregation and redundancy (e.g., RAID), input/output routing, and error detection and recovery. As shown in FIG. 1, a storage controller 114 may coupled to a connector on a switch 110. Also as shown in FIG. 1, system 100 may include a plurality of storage controllers 114, and in such embodiments, storage controllers 114 may be configured as redundant. In addition or in the alternative, storage controllers 114 may in some embodiments be shared among two or more information handling systems 102. As also shown in FIG. 1, each storage controller 114 may be coupled to one or more storage interfaces 126 via cables 124. For example, in some embodiments, each storage controller 114 may be coupled to a single associated storage interface 126 via a cable 124. In other embodiments, each storage controller 114 may be coupled to two or more storage interfaces 126 via a plurality of cables 124, thus permitting redundancy as shown in FIG. 1. Storage controllers 114 may also have features supporting shared storage and high availability. For example, in PCIe implementations, a unique PCIe identifier may be used to indicate shared storage capability and compatibility in system 100.

As depicted in FIG. 1, switch 110 may have coupled thereto one or more slots 120. A slot 120 may include any system, device, or apparatus configured to allow addition of one or more expansion cards to chassis 101 in order to electrically coupled such expansion cards to a switch 110. Such slots 120 may comprise any suitable combination of full-height risers, full-height slots, and low-profile slots. A full-height riser may include any system, device, or apparatus configured to allow addition of one or more expansion cards (e.g., a full-height slot) having a physical profile or form factor with dimensions that practically prevent such expansion cards to be coupled in a particular manner (e.g., perpendicularly) to mid-plane 106 and/or switch 110 (e.g., the proximity of information handling resources in chassis 101 prevents physical placement of an expansion card in such a manner). Accordingly, a full-height riser may itself physically couple with a low-profile to mid-plane 106, a switch 110, or another components, and full-height cards may then be coupled to full-height slots of a full-height riser. On the other hand, low-profile slots may be configured to couple low-profile expansion cards to switches 110 without the need for a full-height riser.

Slots 120 may also include electrically conductive elements (e.g., edge connectors, traces, etc.) allowing for expansion cards inserted into slots 120 to be electrically coupled to switches 110. In operation, switches 110 may manage switching of communications between individual information handling systems 102 and expansion cards coupled to slots 120. In some embodiments, slots 120 may be nonshared (e.g., each slot 120 is associated with a single information handling system 102). In other embodiments, one or more of slots 120 may be shared among two or more information handling systems 102. In these and other embodiments, one or more slots 120 may be configured to be compatible with PCIe, generalized PC bus switch, Infiniband, or other suitable communication specification, standard, or protocol.

Network interface 116 may include any suitable system, apparatus, or device operable to serve as an interface between chassis 101 and an external network (e.g., a local area network or other network). Network interface 116 may enable information handling systems 102 to communicate with the external network using any suitable transmission protocol (e.g., TCP/IP) and/or standard (e.g., IEEE 802.11, Wi-Fi). In certain embodiments, network interface 116 may include a network interface card (“NIC”). In the same or alternative embodiments, network interface 116 may be configured to communicate via wireless transmissions. In the same or alternative embodiments, network interface 116 may provide physical access to a networking medium and/or provide a low-level addressing system (e.g., through the use of Media Access Control addresses). In some embodiments, network interface 116 may be implemented as a local area network (“LAN”) on motherboard (“LOM”) interface.

In some embodiments, various components of chassis 101 may be coupled to a planar. For example, a planar may interconnect switches 110, chassis management controller 112, storage controllers 114, network interface 116, optical media drive 132, KVM interface 134, user interface 136, and/or other modular information handling resources of chassis 101 to mid-plane 106 of system 100. Accordingly, such planar may include slots and/or connectors configured to interconnect with such information handling resources.

Storage interfaces 126 may include any system, device, or apparatus configured to facilitate communication between storage controllers 114 and disk drives 130. For example, a storage interface may serve to permit a relatively small number of communication links (e.g., two) between storage controllers 114 and storage interfaces 126 to communicate with greater number (e.g., 25) disk drives 130. Thus, a storage interface 126 may provide a switching mechanism and/or disk drive addressing mechanism that allows an information handling system 102 to communicate with numerous disk drives 130 via a limited number of communication links and/or channels. Accordingly, a storage interface 126 may operate like an Ethernet hub or network switch that allows multiple systems to be coupled using a single switch port (or relatively few switch ports). A storage interface 126 may be implemented as an expander (e.g., a Serial Attached SCSI (“SAS”) expander), an Ethernet switch, a FibreChannel switch, Internet Small Computer System Interface (iSCSI) switch, or any other suitable switch. In order to support high availability storage, system 100 may implement a plurality of redundant storage interfaces 126, as shown in FIG. 1.

Disk drive backplane 128 may comprise any system, device, or apparatus configured to interconnect modular storage interfaces 126 with modular disk drives 130. Accordingly, disk drive backplane 128 may include slots and/or connectors configured to receive storage interfaces 126 and/or disk drives 130. In some embodiments, system 100 may include two or more backplanes, in order to support differently-sized disk drive form factors. To support redundancy and high availability, a backplane 128 may be configured to receive a plurality (e.g., 2) of storage interfaces 126 which couple two storage controllers 114 to each disk drive 130.

Each disk drive 130 may include computer-readable media (e.g., magnetic storage media, optical storage media, opto-magnetic storage media, and/or other type of rotating storage media, flash memory, and/or other type of solid state storage media) and may be generally operable to store data and/or programs (e.g., one or more operating systems and/or one or more application programs). Although disk drives 130 are depicted as being internal to chassis 101 in FIG. 1, in some embodiments, one or more disk drives may be located external to chassis 101 (e.g., in one or more enclosures external to chassis 101).

Optical media drive 132 may be coupled to mid-plane 106 and may include any suitable system, apparatus, or device configured to read data from and/or write data to an optical storage medium (e.g., a compact disc, digital versatile disc, blue laser medium, and/or other optical medium). In certain embodiments, optical media drive 132 may use laser light or other electromagnetic energy to read and/or write data to an optical storage medium. In some embodiments, optical media drive 132 may be nonshared and may be user-configurable such that optical media drive 132 is associated with a single information handling system 102.

KVM interface 134 may be coupled to mid-plane 106 and may include any suitable system, apparatus, or device configured to couple to one or more of a keyboard, video display, and mouse and act as switch between multiple information handling systems 102 and the keyboard, video display, and/or mouse, thus allowing a user to interface with a plurality of information handling systems 102 via a single keyboard, video display, and/or mouse.

User interface 136 may include any system, apparatus, or device via which a user may interact with system 100 and its various information handling resources by facilitating input from a user allowing the user to manipulate system 100 and output to a user allowing system 100 to indicate effects of the user's manipulation. For example, user interface 136 may include a display suitable for creating graphic images and/or alphanumeric characters recognizable to a user, and may include, for example, a liquid crystal display, cathode ray tube, a plasma screen, and/or a digital light processor projection monitor. In certain embodiments, such a display may be an integral part of chassis 101 and receive power from power supplies (not explicitly shown) of chassis 101, rather than being coupled to chassis 101 via a cable. In some embodiments, such display may comprise a touch screen device capable of receiving user input, wherein a touch sensor may be mechanically coupled or overlaid upon the display and may comprise any system, apparatus, or device suitable for detecting the presence and/or location of a tactile touch, including, for example, a resistive sensor, capacitive sensor, surface acoustic wave sensor, projected capacitance sensor, infrared sensor, strain gauge sensor, optical imaging sensor, dispersive signal technology sensor, and/or acoustic pulse recognition sensor. In these and other embodiments, user interface 136 may include other user interface elements (e.g., a keypad, buttons, and/or switches placed in proximity to a display) allowing a user to provide input to system 100. User interface 136 may be coupled to chassis management controllers 112 and/or other components of system 100, and thus may allow a user to configure various information handling resources of system 100 (e.g., assign individual information handling systems 102 to particular information handling resources).

When a system (e.g., system 100) is architected so as to allow information handling information handling resources (e.g., Peripheral Component Interconnect Express (“PCIe”) adapters coupled to slots 120) to be located in a chassis having shared resources such that the information handling resources may be assigned to one information handling system or shared among a plurality of information handling resources, challenges may arise when needing to service an information handling resource.

Shared resources or devices, such as PCIe adapters coupled to slots 120, may be virtualized across multiple information handling systems 102. Non-shared resources or devices may be partitioned such that they are visible only to a single information handling system 102 at time. Chassis management controller 112 may be configured to handle routing and switching through switches 110 to affect sharing or a resource to multiple information handling systems 102 or to affect dedicated assignment of a resource to a single information handling system 102.

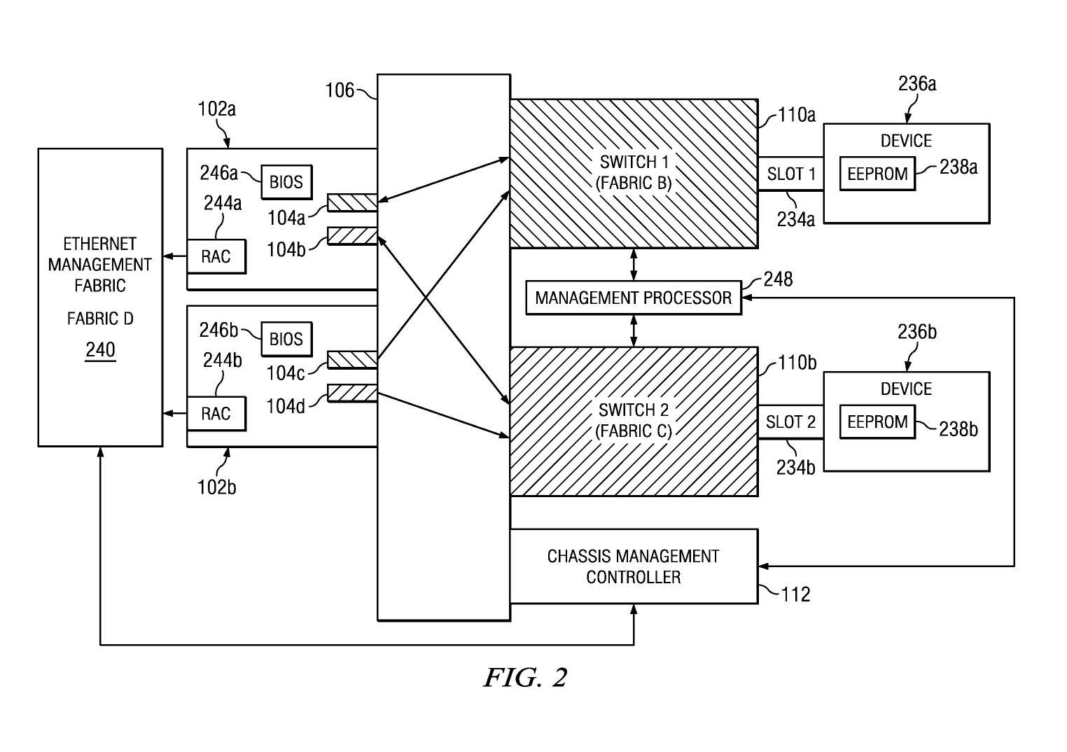

FIG. 2 illustrates a more detailed block diagram of example system 100 configured to provide for dynamic power allocation of information handling resources in a modular chassis 101 for switches and devices in a multi-root input-output virtualization (“IOV”) environment for multiple information handling systems in accordance with certain embodiments of the present disclosure.

As shown in FIG. 2, chassis 101 may include a management processor 248 communicatively coupled to one or more of chassis management controller 112 and switches 110. Management processor 248 may be any system, device, or apparatus configured to facilitate management and/or control of switches 110. Management processor 248 may be configured to issue commands and/or other signals to switches 110. Management processor 248 may comprise a microprocessor, microcontroller, DSP, ASIC, EEPROM, or any combination thereof. In one embodiment, management processor 248 may run a Linux operating system and include application-programming-interfaces (“APIs”) for supporting configuration of IOV in system 100 for sharing devices connected to slots 120 of chassis 101 to multiple information handling systems 102. The APIs of management processor 248 may provide the interface to chassis management controller 112 for configuring IOV. Management processor 248 may be configured to manage both switches 110. In one embodiment, management processor 248 may be communicatively coupled to an Ethernet management fabric 240 and to information handling systems 102. In another embodiment, chassis management controller 112 may be communicatively coupled to the information handling systems 102 through Ethernet management fabric 240. Chassis management controller 112 may be directly communicatively coupled to the Ethernet management fabric 240 or through, for example, management processor 248.

Although FIG. 2 depicts management controller 248 operable to facilitate management and/or control of switches 110, in some embodiments of the present disclosure, one or more chassis management controllers 112 may be configured to perform the functionality of management controller 248, in which a management controller 248 independent of the chassis management controllers 112 may not be present.

Chassis 101 may include multiple information handling systems 102. Chassis 101 may include any suitable number of information handling systems 102. In some embodiments, information handling systems 102 may be referred to as “blades”.

Each information handling system 102 may include switch interfaces 104, as described in association with FIG. 1. Information handling systems 102 may include a basic input-output system 246 (“BIOS”) which may be implemented, for example, on firmware for execution by the information handling system. Information handling system 102 may access BIOS upon, for example, start-up of information handling system 102 to initialize interoperation with the rest of chassis 101.

Information handling system 102 may include a remote access controller 244. Remote access controller 244 may be implemented by, for example, a microprocessor, microcontroller, DSP, ASIC, EEPROM, or any combination thereof. Remote access controller 244 may be configured to communicate with on or more of chassis management controller 112 and management processor 248. Such communication may be made, for example, through Ethernet management fabric 240. Remote access controller 244 may be configured to provide out-of-band management facilities for management of information handling system 102. Such management may be made by elements of chassis 101 even if information handling system 102 is powered off or powered to a standby state. Remote access controller 244 may include a processor, memory, and network connection separate from the rest of information handling system 102. In certain embodiments, remote access controller 244 may include or may be an integral part of a baseboard management controller (BMC), Dell Remote Access Controller (DRAC) or an Integrated Dell Remote Access Controller (iDRAC). Remote access controller 244 may be communicatively coupled to BIOS 246.

Switches 110 may contain PCIe cards instead of the typical blade Ethernet, Fibre Channel or InfiniBand cards. Interfaces 104 of the information handling systems 102 may couple to switches 110 through the switch interfaces 104 of switches 110. Switches 110 may couple information handling systems 102 to slots 234. Slots 234 may include one or more of the slots 120 of FIG. 1 in any suitable combination.

In one embodiment, each of information handling systems 102 may be communicatively coupled to each of switches 110 through one of switch interfaces 104 resident on the information handling system 102. For example, information handling system 102a may be communicatively coupled to switch 110a through switch interface 104a and to switch 110b through switch interface 104b. Information handling system 102b may be communicatively coupled to switch 110a through switch interface 104c and to switch 110b through switch interface 104d. Thus, each of switches 110 may provide its switching fabric to each of information handling systems 102 in order to route the given information handling system 102 to respective slots 234 associated with the switch 110.

Slots 234 may be configured to couple to associated devices 236, though fewer devices may be present than the associated capacity of chassis 101. Chassis 101 may include any suitable number of slots 234. In some embodiments, devices 236 may include PCIe-based cards or devices. Each such device 236 may represent an information handling resource to be selectively shared among multiple information handling system 102 or dedicated to a single information handling system 102. A device 236 may comprise, for example, a RAID controller, network card, or other information handling resource. Furthermore, a device 236 may include a specific shared component such as a network interface card (“NIC”) 236. Devices 236 may include management information or circuitry configured to provide information to chassis 101 regarding the operation or specification of device 236. For example, a device 236 may include EEPROM 238 containing such information.

In order to support IOV, the driver and firmware of device 236 may include support for single root IOV (SR-IOV). To maintain routes between given information handling systems 102 and slots 234, switches 110 may include virtual hierarchies from slots 234 to information handling systems 102. Particular functions, such as virtual functions or shared functions, for SR-IOV for a given device 236 may be mapped in switch 110, providing behavior similar to multiple-root IOV (MR-IOV). Thus, in such case, a switch 110 may be considered a Multi-Root Aware (MRA) switch which bridges MR-IOV to SR-IOV so that SR-IOV virtual functions may be exposed to a mode as physical function, such that an information handling system 102 is not aware that a given device 236 is shared. In one embodiment, wherein device 236 contains multiple information handling resources such as a NIC and USB interface, a function may be provided for each such information handling resource. Thus, from the perspective of information handling systems 102 the multiple such information handling resources may appear to be separate and unrelated. A given slot 234 or device 236 which has been virtualized may be accessed by two or more virtual functions, which allow the sharing of the resource. Physical functions, as opposed to the above-described virtual functions or shared functions, may be mapped or stored in management processor 248. A physical function representing an information handling resource may be provided to a single information handling system 102. In cases where a device 236 contains multiple information handling resources, individual physical functions may be provided for each such resource. Multiple instances of a virtual function may be provided to multiple information handling systems 102. If, for example, multiple information handling systems 102 are sharing a device 236, then access to device 236 may be divided into multiple virtual NICs using virtual functions, each of which are mapped by switches 110 to the respective information handling system 102. Furthermore, specific APIs for accessing a given device 236 may be mapped or stored in management processor 248. Chassis management controller 112 may be configured to access these physical functions or APIs in management processor 248.

In some embodiments of system 100, many devices 236 of the same or similar functionality may be coupled to slots 234. In addition, such devices 236 may be shared among multiple information handling systems 102 or may be dedicated to a single information handling system 102. When a device 236 is shared among multiple information handling systems 102, and such device 236 becomes degraded (e.g., fails or becomes overused beyond its capacity), such degradation can result in loss of functionality of one or more of the information handling systems 102 associated with the device 236, all the while a device 236 with the same functionality may be sitting idle or well under capacity in another slot 234. Thus, a mechanism for dynamically allocating devices 236 to information handling systems 236 may be desirable.

Because information handling resources, such as those in devices 236 coupled to slots 234, are not located within an information handling system 102, but rather in a shared chassis using switches 110 to virtualize and route input/output communications among selected information handling systems 102, allocation of such information handling resources may not be directly controlled by an associated information handling system 102. Consequently, allocation of information handling resources such as devices 236 with information handling systems 102 in chassis 101 may be conducted by chassis management controller 112. As described in greater detail below, chassis management controller 112 may be configured to allocate or otherwise direct other components of chassis 101 to allocate devices 236 to information handling systems 102. It is noted that while the functionality described herein contemplates virtualization for shared devices 236, the functionality described herein may also be extended to nonshared devices as well.

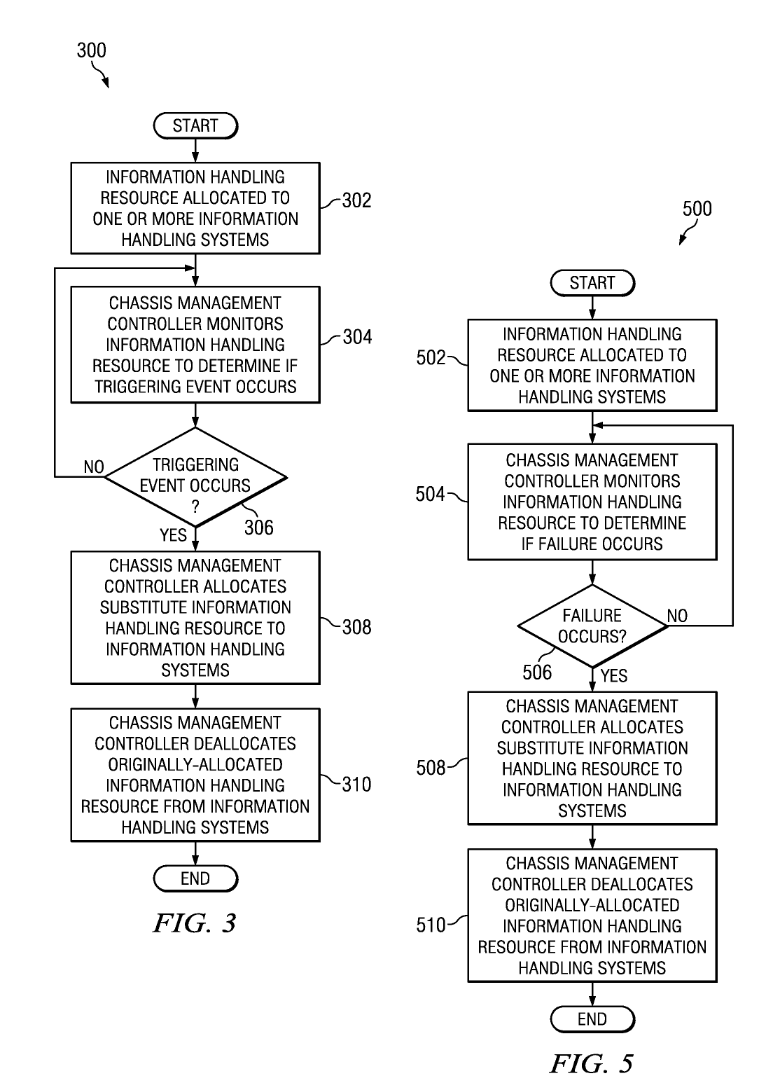

FIG. 3 illustrates a flow chart of an example method 300 for dynamic allocation of information handling resources to information handling systems 102 in a chassis 101, in accordance with certain embodiments of the present disclosure. According to certain embodiments, method 300 may begin at step 302. As noted above, teachings of the present disclosure may be implemented in a variety of configurations of system 100 as shown in FIGS. 1 and 2. As such, the preferred initialization point for method 300 and the order of the steps comprising method 300 may depend on the implementation chosen.

In these and other embodiments, method 300 may be implemented as firmware, software, applications, functions, libraries, or other instructions continually monitoring chassis 101 for such powering on. In a further embodiment, method 300 may be implemented fully or partially by such instructions embodied within chassis management controller 112.

At step 302, a chassis management controller 112 may allocate an information handling resource (e.g., a device 236 or a virtual function capable of executing on a device 236) to one or more information handling systems 102. At step 304, a chassis management controller may monitor the information handling resource to determine if a triggering event occurs. A triggering event may be any event by which one or more particular operating parameters of the information handling resource meet specified criteria. For example, a triggering event may include a particular bandwidth threshold for the information handling resource being exceeded, a particular performance level being reached, issuance of an alert related to the information handling resource, etc. The specified criteria for a triggering event may be established by an individual (e.g., user or administrator of the information handling resource), established by one or more information handling resources of system 100, and/or in any other suitable manner.

If, at step 306, the triggering event occurs, method 300 may proceed to step 308. Otherwise, steps 304 and 306 may repeat until such time as the triggering event occurs.

At step 308, in response to the triggering event, a chassis management controller 112 may allocate a substitute information handling resource to the one or more information handling systems, the substitute information handling resource may have functionality identical or substantially similar to the originally-allocated information handling resource. In some embodiments, such substitute information handling resource may be a “spare” or “standby” information handing resource already coupled to and/or configured to execute its functionality (e.g., a hot spare or standby device 236 with the same functionality as the information handling resource, or an idle virtual function with the safe functionality as the information handling resource).

At step 310, also in response to the triggering event, a chassis management controller 112 may deallocate the originally-allocated information handling resource from the information handling systems. After step 310, method 300 may end.

As an example of a particular implementation in which method 300 might be used, consider an application in which chassis 101 has two network interface cards respectively coupled to two slots 234/120, and an individual (e.g., user or administrator) couples the network interface cards to a data center switch. Further assume that the individual allocates various multi-root and single-root virtual functions (for the purposes of illustration, assume four virtual functions) to multiple information handling systems with chassis 101, and sets the bandwidth limitations of the virtual functions VF1, VF2, VF3, and VF4 to 5 GB, 2 GB, 2 GB, and 1 GB, respectively. Also assume that the individual establishes a trigger whereby the trigger occurs if either of VF2 or VF3 sustains 2 GB of traffic or more for 15 minutes or more. When such a trigger occurs, chassis management controller 112 may automatically allocate (e.g., map) one or more spare virtual functions with sufficient bandwidth (e.g., VF1) to the information handling systems and move the port configurations from the currently-allocated virtual function to the newly-allocated virtual function(s). In addition, chassis management controller 112 may deallocate (e.g., un-map) the originally-allocated virtual function from its associated information handling systems 102.

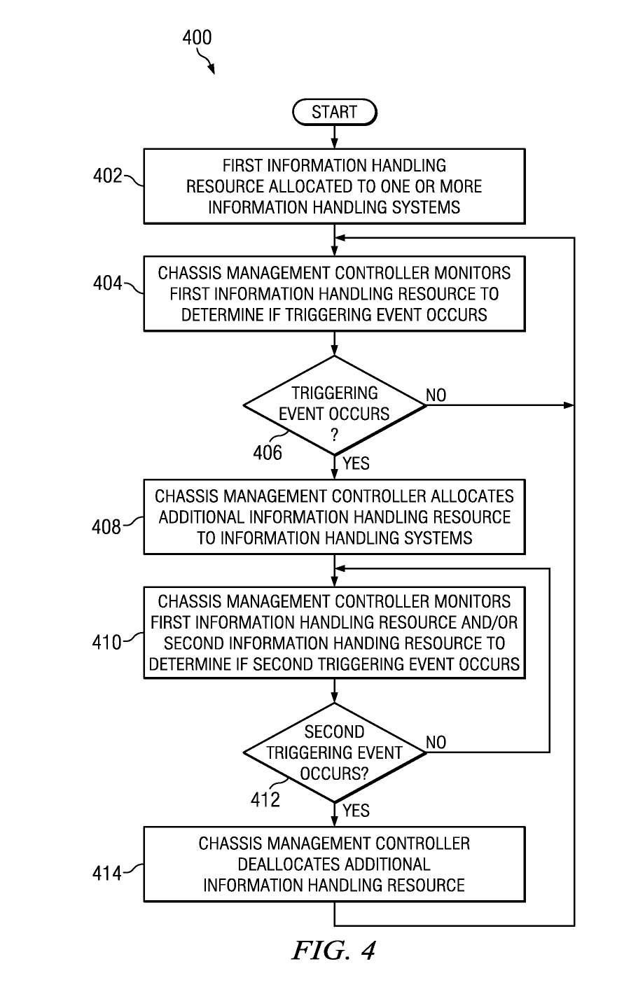

FIG. 4 illustrates a flow chart of another example method 400 for dynamic allocation of information handling resources to information handling systems 102 in a chassis 101, in accordance with certain embodiments of the present disclosure. According to certain embodiments, method 400 may begin at step 402. As noted above, teachings of the present disclosure may be implemented in a variety of configurations of system 100 as shown in FIGS. 1 and 2. As such, the preferred initialization point for method 400 and the order of the steps comprising method 400 may depend on the implementation chosen.

In these and other embodiments, method 400 may be implemented as firmware, software, applications, functions, libraries, or other instructions continually monitoring chassis 101 for such powering on. In a further embodiment, method 400 may be implemented fully or partially by such instructions embodied within chassis management controller 112.

At step 402, a chassis management controller 112 may allocate a first information handling resource (e.g., a device 236 or a virtual function capable of executing on a device 236) to one or more information handling systems 102. At step 404, a chassis management controller may monitor the information handling resource to determine if a first triggering event occurs. The first triggering event may be any event by which one or more particular operating parameters of the information handling resource meet specified criteria. For example, the first triggering event may include a particular bandwidth threshold for the information handling resource being exceeded, a particular performance level being reached, issuance of an alert related to the information handling resource, etc. The specified criteria for the first triggering event may be established by an individual (e.g., user or administrator of the information handling resource), established by one or more information handling resources of system 100, and/or in any other suitable manner.

If, at step 406, the first triggering event occurs, method 400 may proceed to step 408. Otherwise, steps 404 and 406 may repeat until such time as the triggering event occurs.

At step 408, in response to the first triggering event, a chassis management controller 112 may allocate an additional information handling resource to all or a portion of the one or more information handling systems, the additional information handling resource may have functionality identical or substantially similar to the first information handling resource. In some embodiments, such additional information handling resource may be a “spare” or “standby” information handing resource already coupled to and/or configured to execute its functionality (e.g., a hot spare or standby device 236 with the same functionality as the information handling resource, or an idle virtual function with the safe functionality as the information handling resource). In operation, processing and functionality originally carried out by the first information handling resource may now be shared between the first information handling resource and the additional information handling resource.

At step 410, chassis management controller 112 may monitor the first information handling resource and/or the additional information handling resource to determine if a second triggering event has occurred. Occurrence of the second triggering event may indicate the additional information handling resource is no longer needed, and that the processing and functionality shared by the first information handling resource and the additional information handling resource may be performed solely by the first information handling resource. The second triggering event may be any event by which one or more particular operating parameters of the first information handling resource and/or the additional information handling resource meet specified criteria. For example, the second triggering event may include a particular bandwidth threshold for the first information handling resource and/or additional information handling resource being exceeded, a particular performance level being reached, issuance of an alert related to the first information handling resource and/or additional information handling resource, etc. The specified criteria for the second triggering event may be established by an individual (e.g., user or administrator of the information handling resource), established by one or more information handling resources of system 100, and/or in any other suitable manner.

If, at step 412, the second triggering event occurs, method 400 may proceed to step 414. Otherwise, steps 410 and 412 may repeat until such time as the triggering event occurs.

At step 414, in response to the second triggering event, a chassis management controller 112 may de-allocate the additional information handling resource from its associated information handling systems, and return all processing and functionality shared by the first information handling resource and the additional information handling resource to the first information handling resource.

As an example of a particular implementation in which method 400 might be used, consider an application in which chassis 101 has three general purpose graphics units (GPGUs) respectively coupled to three slots 234/120. Further assume that an individual allocates a first GPGU to a first information handling system 102, allocates a second GPGU to a second information handling system 102, and does not allocate the third GPGU to any information handling system 102, thus making the third GPGU a “spare” or “standby” GPGU. Also assume that the individual establishes a first trigger whereby the trigger occurs if either of the first GPGU or second GPGU experiences 90% or more of its performance capacity for more than two minutes. When such a trigger occurs, chassis management controller 112 may automatically allocate (e.g., map) the third GPGU to the information handling system 102 associated with the GPGU experiencing the triggering event, and the third GPGU may then assist in computation. A second trigger may exist whereby, once mapped to an information handling system, the third GPGU may be de-allocated and placed back into the standby pool once it experiences a certain percentage or less (e.g., 40%) of its performance capacity for a particular period of time (e.g., two minutes).

FIG. 5 illustrates a flow chart of an example method 500 for failover of an information handling resources associated with one more information handling systems 102 in a chassis 101, in accordance with certain embodiments of the present disclosure. According to certain embodiments, method 500 may begin at step 502. As noted above, teachings of the present disclosure may be implemented in a variety of configurations of system 100 as shown in FIGS. 1 and 2. As such, the preferred initialization point for method 500 and the order of the steps comprising method 500 may depend on the implementation chosen.

In these and other embodiments, method 500 may be implemented as firmware, software, applications, functions, libraries, or other instructions continually monitoring chassis 101 for such powering on. In a further embodiment, method 500 may be implemented fully or partially by such instructions embodied within chassis management controller 112.

At step 502, a chassis management controller 112 may allocate an information handling resource (e.g., a device 236 or a virtual function capable of executing on a device 236) to one or more information handling systems 102. At step 504, a chassis management controller may monitor the information handling resource to determine if a failure occurs. A failure may be any event in which the information handling resource is unable to substantially perform its intended function (e.g., removal from a slot, electronic failure, etc.).

If, at step 506, the failure occurs, method 500 may proceed to step 508. Otherwise, steps 504 and 506 may repeat until such time as the triggering event occurs.

At step 508, in response to the failure, a chassis management controller 112 may allocate a substitute information handling resource to the one or more information handling systems, the substitute information handling resource may have functionality identical or substantially similar to the originally-allocated information handling resource. In some embodiments, such substitute information handling resource may be a “spare” or “standby” information handling resource already coupled to and/or configured to execute its functionality (e.g., a hot spare or standby device 236 with the same functionality as the information handling resource, or an idle virtual function with the safe functionality as the information handling resource).

At step 510, also in response to the failure, a chassis management controller 112 may deallocate the originally-allocated information handling resource from the information handling systems. After step 510, method 500 may end.

As an example of a particular implementation in which method 500 might be used, consider an application in which chassis 101 has three network interface cards respectively coupled to three slots 234/120. Further assume that an individual allocates a first network interface card to a first information handling system 102, allocates a second network interface card to a second information handling system 102, and does not allocate the third network interface card to any information handling system 102, thus making the third network interface card a “spare” or “standby” network interface card. In the event the chassis management controller 112 receives an indication that a network interface card has failed (e.g., via a remote access controller 244) the chassis management controller 112 may respond to the indication by communicating a instruction to the information handling system 102 to which the network interface card is allocated (e.g., instruct a remote access controller 244 of the information handling system 102 to issue a Rip and Replace action). Such action would copy the network interface card configuration information and inform the chassis management controller that the information handling system 102 is ready to have its network interface card replaced. The chassis management controller 112 may un-map the failed network interface card and mark it as failed or unavailable so that it would not become a standby device. The chassis management controller 112 may power on the third network interface card, map it to the information handling system 102 to which the failed network interface card was allocated, and inform the information handling system 102 (e.g., via remote access controller 244) that the third network interface card is the replacement for the failed network interface card. The information handling system 102 may copy the saved configuration information to the third network interface card, and the third network interface card would be made available to the information handling system 102.

Although FIGS. 3-5 disclose a particular number of steps to be taken with respect to methods 300, 400, and 500, methods 300, 400, and 500 may be executed with greater or lesser steps than those depicted in FIGS. 3-5. In addition, although FIGS. 3-5 disclose a certain order of steps to be taken with respect to methods 300, 400, and 500, the steps comprising methods 300, 400, and 500 may be completed in any suitable order.

Methods 300, 400, and 500 may be implemented using system 100, components thereof or any other system such as those shown in FIGS. 1 and 2 operable to implement methods 300, 400, and 500. In certain embodiments, methods 300, 400, and 500 may be implemented partially or fully in software and/or firmware embodied in computer-readable media.

Although the present disclosure has been described in detail, it should be understood that various changes, substitutions, and alterations can be made hereto without departing from the spirit and the scope of the disclosure as defined by the appended claims.

What is claimed is:

1. A system comprising:
a chassis configured to receive a plurality of modular information handling systems and a plurality of modular information handling resources, each information handling resource received through a slot in the chassis;
one or more switches configured to provide access of one of the modular information handling resources to one or more of the plurality of modular information handling systems;
one or more chassis management controllers housed in the chassis and configured to:
monitor a first information handling resource allocated to one or more modular information handling systems engaged in the chassis to determine if a triggering event associated with the first information handling resource occurs;
in response to the triggering event, allocate a substitute information handling resource for the one or more information handling systems to which the first information handling resource is allocated; and
in response to the triggering event, deallocate the first information handling resource from the one or more information handling systems to which the first information handling resource is allocated.

2. A system according to claim 1, wherein each information handling resource comprises a virtual function configured to execute on a device coupled to a corresponding slot.

3. A system according to claim 1, the triggering event comprising a particular bandwidth threshold for the first information handling resource being exceeded.

4. A system according to claim 1, the triggering event comprising a particular performance level of the first information resource being achieved.

5. A system according to claim 1, the triggering event comprising an issuance of an alert related to the information handling resource.

6. A system according to claim 1, the one or more switches configured to provide access of one of the modular information handling resources to one or more of the plurality of modular information handling systems by providing virtualized access of the one of the modular information handling resources to one or more of the plurality of modular information handling systems.

7. A system comprising:
a chassis configured to receive a plurality of modular information handling systems and a plurality of modular information handling resources, each information handling resource received through a slot in the chassis;
one or more switches configured to provide access of one of the modular information handling resources to one or more of the plurality of modular information handling systems;
one or more chassis management controllers housed in the chassis and configured to:
monitor a first information handling resource allocated to one or more modular information handling systems engaged in the chassis to determine if a first triggering event associated with the first information handling resource occurs; and
in response to the first triggering event, allocate an additional information handling resource for all of a portion of the one or more information handling systems to which the first information handling resource is allocated, such that processing and functionality carried out by the first information handling resource prior to the occurrence of the first triggering event is shared between the first information handling resource and the additional information handling resource.

8. A system according to claim 7, the one or more chassis management controllers configured to:
monitor at least one of first information handling resource and the additional information handling resource to determine if a second triggering event associated with at least one of the first information handling resource and the second information handling resource occurs; and
in response to the second triggering event, deallocate the additional information handling resource from the one or more information handling systems to which the additional information handling resource is allocated.

9. A system according to claim 7, wherein each information handling resource comprises a virtual function configured to execute on a device coupled to a corresponding slot.

10. A system according to claim 7, the first triggering event comprising a particular bandwidth threshold for the first information handling resource being exceeded.

11. A system according to claim 7, the first triggering event comprising a particular performance level of the first information resource being achieved.

12. A system according to claim 7, the first triggering event comprising an issuance of an alert related to the information handling resource.

13. A system according to claim 7, the one or more switches configured to provide access of one of the modular information handling resources to one or more of the plurality of modular information handling systems by providing virtualized access of the one of the modular information handling resources to one or more of the plurality of modular information handling systems.

14. A system comprising:
a chassis configured to receive a plurality of modular information handling systems and a plurality of modular information handling resources, each information handling resource received through a slot in the chassis;
one or more switches configured to provide access of one of the modular information handling resources to one or more of the plurality of modular information handling systems;
one or more chassis management controllers housed in the chassis and configured to:
monitor a first information handling resource allocated to one or more modular information handling systems engaged in the chassis to determine if a failure associated with the first information handling resource occurs;
in response to the failure, allocate a substitute information handling resource for the one or more information handling systems to which the first information handling resource is allocated; and
in response to the failure, deallocate the first information handling resource from the one or more information handling systems to which the first information handling resource is allocated.

15. A system according to claim 13, wherein each information handling resource comprises a virtual function configured to execute on a device coupled to a corresponding slot.

16. A system according to claim 14, the one or more switches configured to provide access of one of the modular information handling resources to one or more of the plurality of modular information handling systems by providing virtualized access of the one of the modular information handling resources to one or more of the plurality of modular information handling systems.
